(19) United States
(12) Patent Application Publication
(10) Pub. No.: US 2012/0248817 A1
(43) Pub. Date: Oct. 4, 2012

(54) Pop up quick camper

(76) Inventor: Jamin A. Miller, Nitro, WV (US)

(21) Appl. No.: 13/064,495

(22) Filed: Mar. 29, 2011

(51) Int. Cl. B60P 3/32; A44B 18/00; B60P 7/02

(52) U.S. Cl. 296/160; 296/100.06; 24/442; 296/100.01

(57) ABSTRACT

A camping wrap that is comprised of a series of interconnected panels each of which is connected along one edge to interior edge portions of a cover used to close and cover the bed of a vehicle, for example a pick up truck bed, and which when deployed extends around the sides and end of a raised cover and with adjacent edges of the camping wrap being releasably inter-lockable with one another and with bottom portions of the interconnected panels extending downwardly and over the sides and rear of the vehicle.

### COPYRIGHT NOTICE

A portion of the disclosure of this patent document contains material which may be subject to copyright work protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

This disclosure relates to camping equipment and especially equipment designed for use with a pick up truck or similar vehicle having a bed or open back area that can be closed by a cover which could be, for example, a hinged and raiseable tonneau cover.

### INTRODUCTION

One of the most widely sold vehicle types in the United States is pick up trucks. While pick up trucks have many uses, many are sold to individuals that not only enjoy a variety of outdoor activities, but they are used as part of camping trips, for hunting, for weekend travel and so on. What pick up trucks lack is a ready ability to permit the rear bed portion to be used as a place to sleep in a way that individuals are sheltered. While a tent might be used in the bed, many tents are not designed or sized for that purpose and to simply use a sleeping bag in the bed may not provide sufficient shelter from wind, rain, snow or other weather conditions.

The present invention is designed to work with a cover that can close over a rear bed and be raised or opened out of that closed condition, for example, one such cover type is a shell type tonneau cover. A camping wrap has been designed to attach to the interior of the cover and which can be simply deployed when the cover is itself raised to an open position with the camping wrap then providing an enclosed and protected interior space for sleeping, changing or to simply get out of the weather.

Glossary: As used throughout this document:

The phrase “bed” shall mean any type or form of space, for example an open area bounded by sides associated with a vehicle that can be covered by a removable or raise-able cover structure.

The term “camper wrap” shall include structures made from fabric, plastic, composite materials, textiles, nylon or other man made materials, thermoplastics, metal, or combinations of materials, and further which can have a variety of shapes, configurations, deployment schemes and attachment approaches.

### DESCRIPTION OF PRESENTLY PREFERRED EXAMPLES OF THE INVENTION

### Brief Description of Figures

The invention is better understood by reading the following detailed description with reference to the accompanying drawings in which:

FIG. 1 is a side perspective view of a pick up truck showing a rear bed covered by a cover in a closed condition;

FIG. 2 is a side perspective view similar to FIG. 1, but showing the cover raised;

FIGS. 3a and 3b show the inside and outside views of a panel of the camper wrap used on the driver's side

FIGS. 4a and 4b show the inside and outside views of a panel of the camper wrap used on the passenger side:

FIGS. 5a and 5b show the inside and outside views of a panel of the camper wrap used along the rear of the bed;

FIG. 6 is a side perspective showing the camper wrap in a deployed condition providing shelter to the bed;

FIG. 7 is a perspective view of the camper wrap assembly;

FIG. 8 is a more detailed view of a portion of FIG. 2 showing the hinge for the cover;

FIG. 9 is side perspective showing an exemplary panel attaching approach;

FIGS. 10A-10E show additional embodiment for attaching panels to the cover;

FIG. 11 is a side perspective view showing the camper wrap deployed and partially opened at one corner; and

FIG. 12 is a side perspective showing the camper wrap in a stowed condition within the cover.

### DETAILED DESCRIPTION OF THE INVENTION

### A. Overview

To gain a better understanding of the invention, a preferred embodiment will now be described in detail. Frequent reference will be made to the drawings. Reference numerals or letters will be used throughout to indicate certain parts or locations in the drawings. The same reference numerals or letters will be used to indicate the same parts and locations throughout the drawings, unless otherwise indicated.

### B. Environment

The preferred embodiment now described will be with respect to a pick up truck and specifically to the rear portion thereof. The scale of the embodiment, therefore, is to be understood with respect to this type of article. It is to be understood as well, however, that the invention is applicable to other vehicle types where there is any open or coverable area that can be covered by a raise-able or removable cover structure and its scale can vary accordingly.

### C. Structure

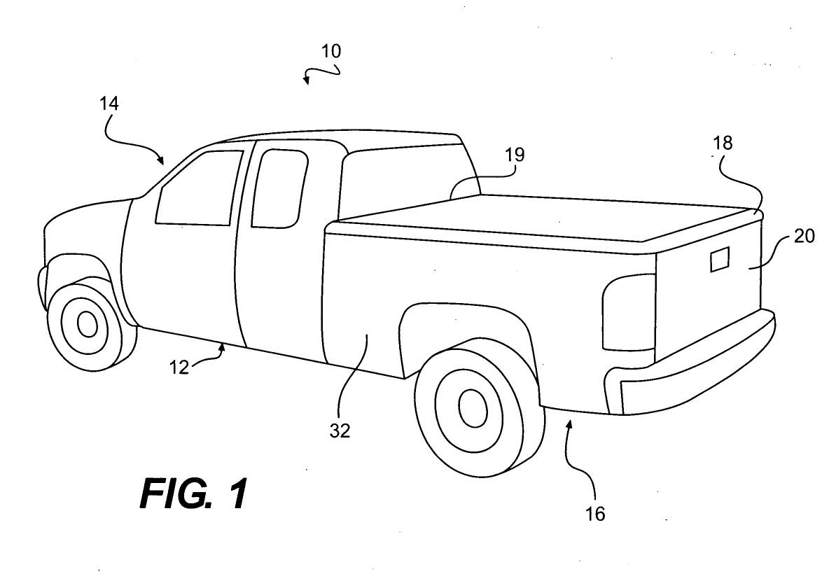

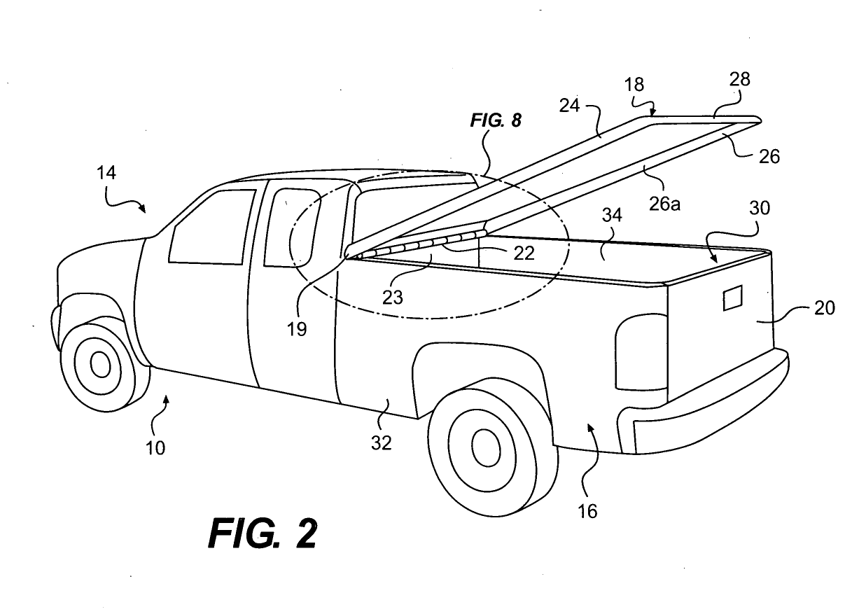

FIG. 1 shows a vehicle 10, for example a pick up truck, shown from the side and as being comprised of a body 12 with a front portion 14 and a rear portion 16 having a cover 18, shown as being closed, and a tail gate 20. Cover 18 can be, for example, a tonneau cover shown in FIG. 2 in a raised position, but it should be understood that cover 18 can be any form of cover that can be raised, tilted open, opened by being raised vertically or in any other manner so long as it covers bed 30 and can be moved between closed and open positions.

As shown in FIG. 2, cover 18 is in an open position thereby uncovering bed 30 that is formed from truck sidewalls 32 and 34 that cooperate with tail gate 20 to define the dimensions and size of bed 30 in the rear portion 16. Cover 18 can, for example, be connected at a rear edge 19 to body 12 by a hinge 22 located at the top of a front bed wall 23 and hinge 22 preferably extends across the width of the bed 30. Cover 18 also has depending side portions 24 and 26 and a rear portion 28 that preferably extend outwardly over sidewalls 32 and 34 as well as the rear tailgate 20 when cover 18 is closed or which can mate with and seal around the upper edges of walls 23, 32, 34 and tail gate 20.

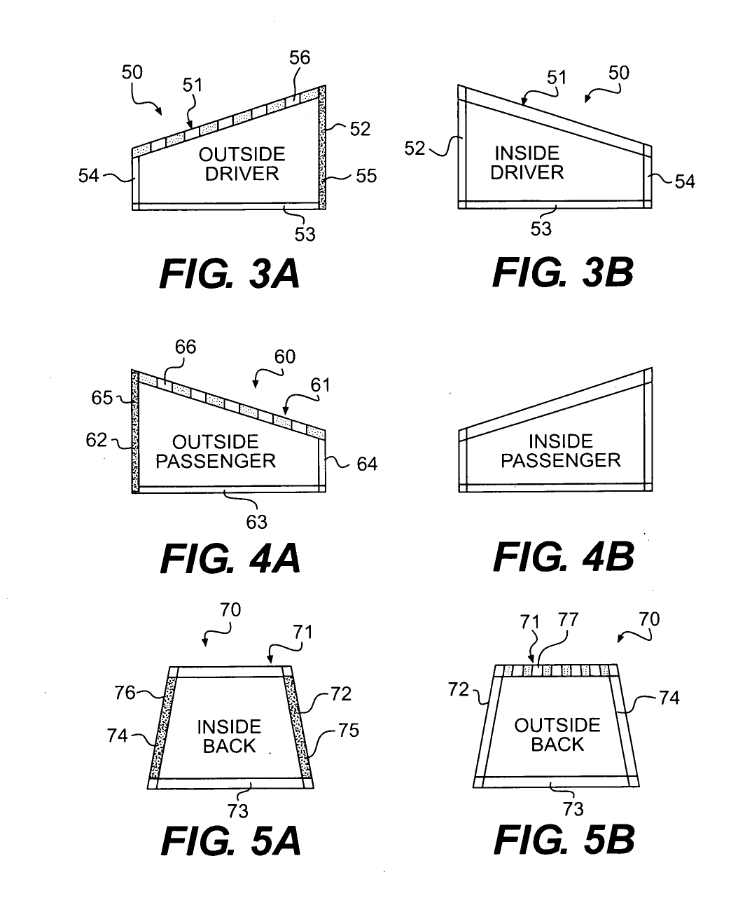

FIGS. 3a-5b show the individual pieces of a camper wrap 40 that is comprised of three panels, 50, 60 and 70, with both outside and inside views of the three panels 50, 60 and 70 being respectively set forth in these FIGS. 3a-5b, that collectively form the camper wrap 40 that can be deployed when cover 18 is raised as in FIG. 2. Camper wrap 40 is shown in FIG. 2 in its deployed condition with portions being cut away to show a portion of the interior thereof.

FIGS. 3a and 3b show panel 50 that is the one on the driver's side of the camper wrap 40 and is defined by four sides. A top side 51, two ends 52 and 54 and a bottom 53. FIG. 3a shows an outside view of panel 50 while FIG. 3b shows an inside view thereof. As one example of sizing of panel 50 the top side can be about 79 inches long, the long end 52 can be about 36 inches long, the short end 54 can be about 12 inches or one foot and the bottom side 53 can extend for about 74 inches. Those dimensions allow panel 50 to hang down sufficiently to over hang side 32 of the vehicle.

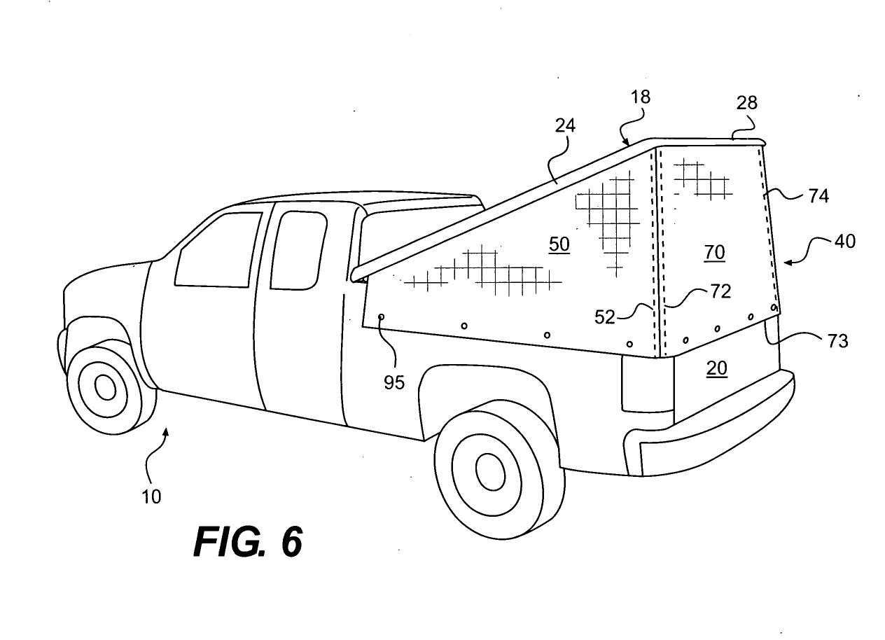

FIGS. 4a and 4b show panel 60 that is located on the passenger side of the vehicle and like panel 50 has a top side 60, a long end 62, a short end 64 and a bottom 63. Its dimensions can mirror those of panel 50, noted above, and will, when deployed, over hang side 34. Also, FIG. 4a shows an outside view of panel 60 while FIG. 4b shows an inside view thereof.

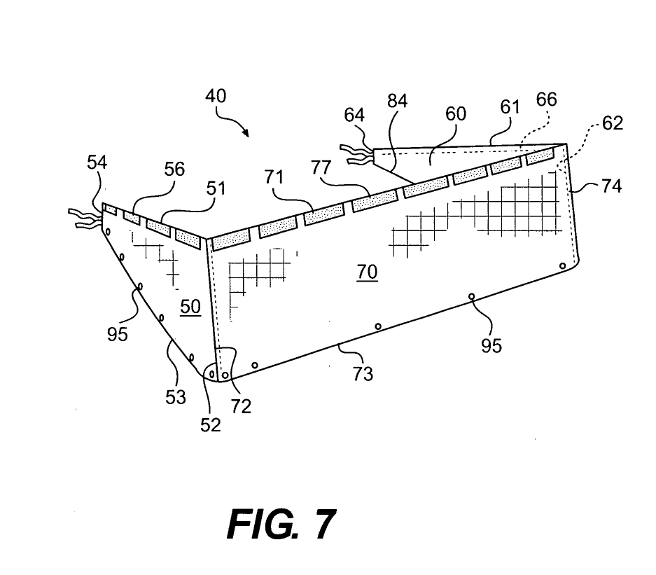

FIGS. 5a and 5b show outside and inside views, respectively, of panel 70 that will be the rear panel part of camper wrap 40. It has a top side 71, two ends 72 and 74, and a bottom 73. The shape of panel 70 is preferably trapezoidal, but other shapes could be used, for example, a square or rectangle, depending upon the cover being used, the bed shape and the type of vehicle being covered. The top side 71 can be about 69 inches long, the two ends 62 and 64 can be about 41 inches, and the bottom 73 can be about 90 inches long.

As shown in FIG. 3a a strip of Velcro 55 can be sown in place on the outside of end 52 so as to extend along the whole length thereof. In a similar fashion FIG. 4a shows another strip of Velcro 65 attached to end 62 of panel 60. Further, as shown in FIG. 5a rear panel 70 has companion Velcro strips 75 and 76 attached along ends 72 and 74, respectfully.

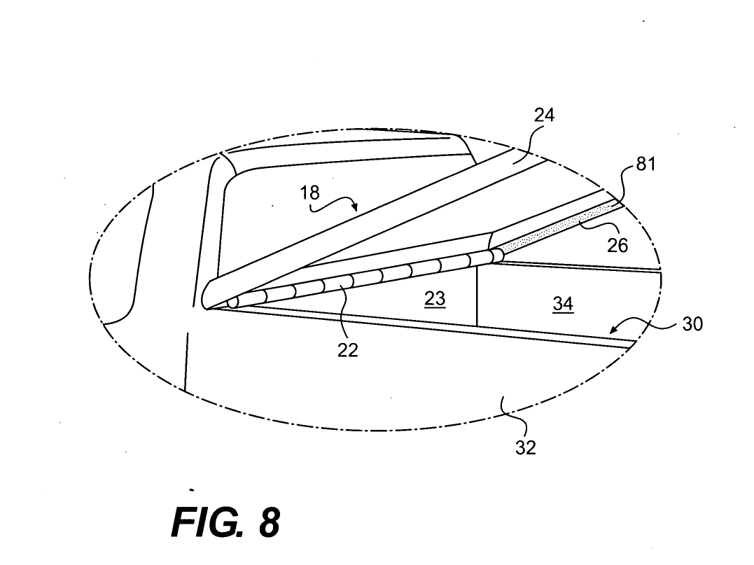

When camping wrap 40 is deployed, as shown in FIGS. 6, 7 and 11, deployed panels 50, 60 and 70 will be hanging loosely in a downward fashion and ends 52 and 72 will be adjacent one another while ends 62 and 74 will also be adjacent one another. It is important that the outermost adjacent ends 52/72 and 72/64 be held together, interlocked or removably joined to one another in order to fully close the shelter camping wrap 40 is intended to provide. One example for achieving such end closures would be to use elongated or spaced apart pieces of Velcro strips 55 and 75, that can secure ends 52 and 72 together and similar Velcro strips 76 and 75 that can secure ends 74 and 62 together, respectively.

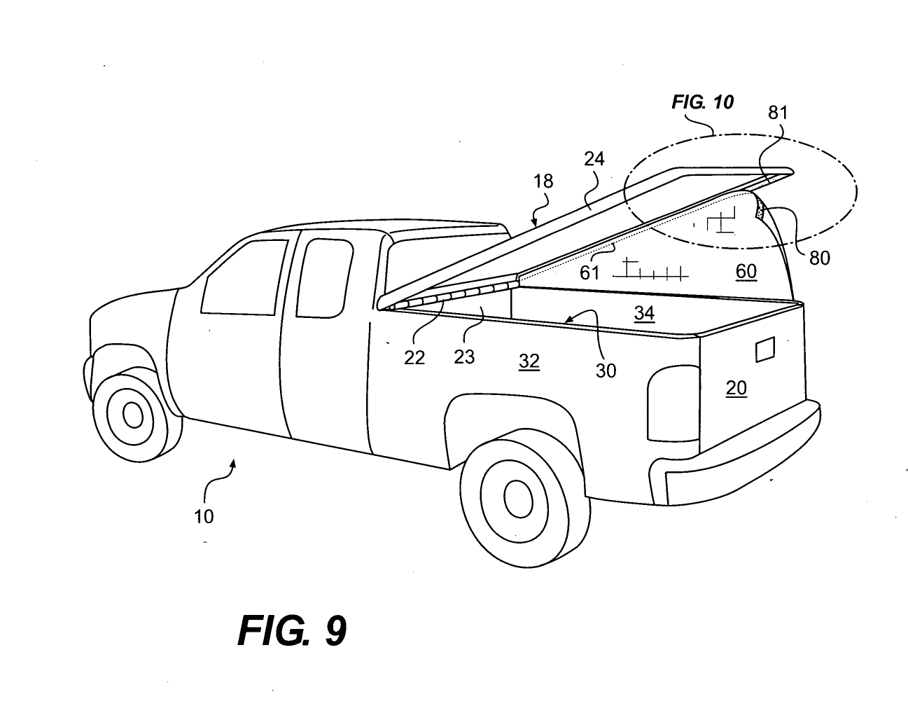

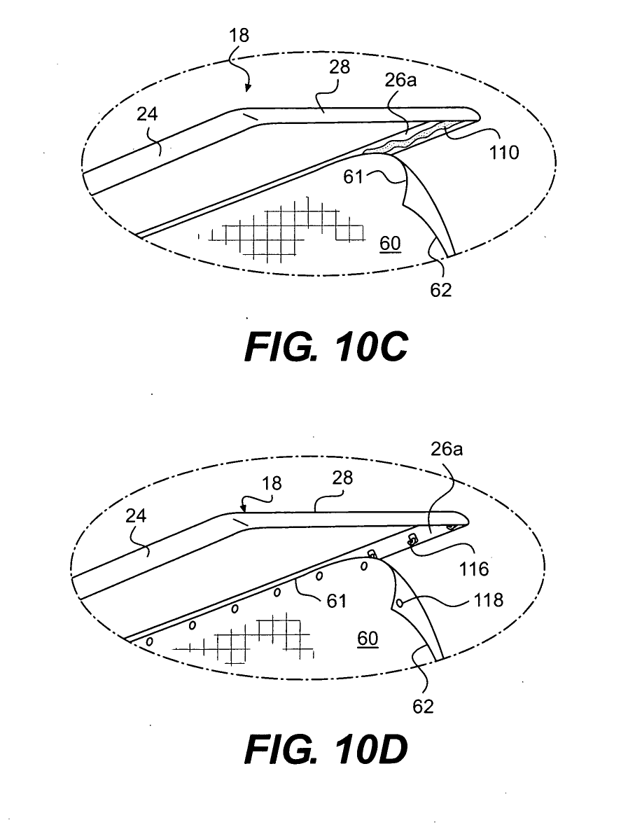

FIGS. 7-10E show different embodiments of approaches that can be used to attach, or more preferably removably attach the top sides of panels 50, 60 and 70 to cover and specifically to an interior area of side portions 24, 26 and 28 of cover 18.

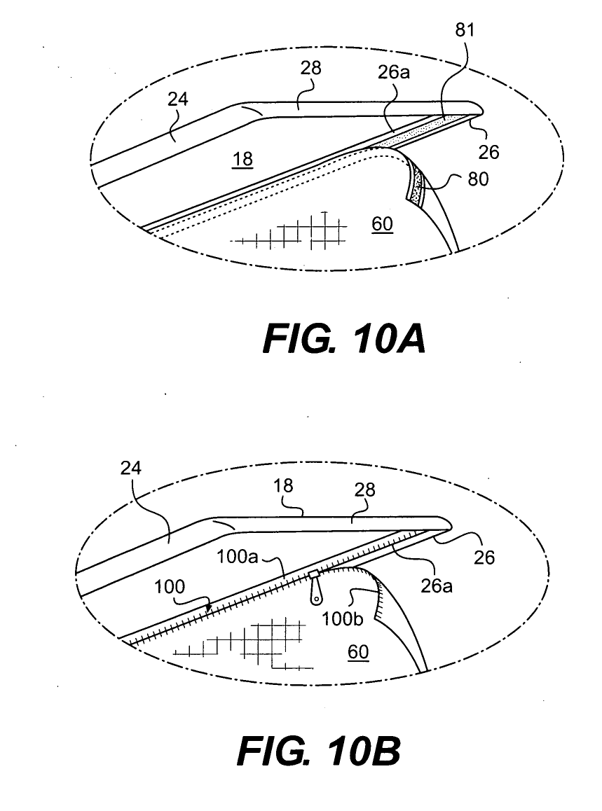

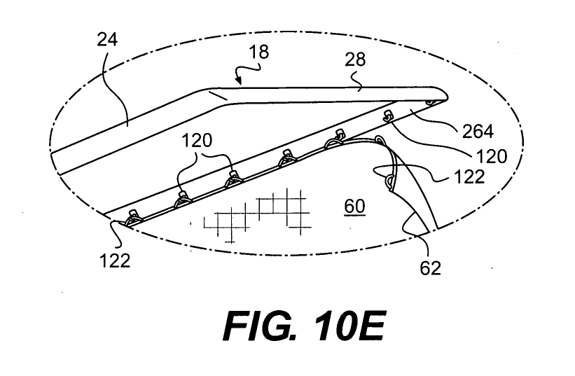

For, example, with reference to FIGS. 7-10A, the inside portion of the cover side portions 24-28 can be provided with a Velcro strip 81 as shown in FIGS. 8-10A, for example by use of an adhesive or by heat staking, and each panel's respective top sides, 51, 61 and 71 can be provide with complimentary Velcro material, either in the form a strip as shown at 80 in FIG. 10A or in the form of spaced apart Velcro pieces as shown in FIGS. 3a, 4a, 5a and 7 at 56, 66 and 77 for panels 50, 60 and 70, respectively.

In another embodiment, as shown in FIG. 10B the two parts 100a and 100b of a zipper 100 could be provided on a panel's top side, for example as shown for panel 60 and on the inside portion 26a of cover 18 so that a panel could be removably attached by that zipper.

FIG. 10C shows use of an adhesive 110 placed on an inside edge 26a of cover 18 so that the top side 61 of a panel 60 could then be attached by adhesive, which could, for example, comprise polyester resins, polyurethane resins, Acrylic polymers, elastomers, thermoset adhesives, thermoplastics, epoxy resins or other similar adhesive materials.

FIG. 10D shows use of a plurality of spaced apart hooks 116 provided on cover portion 26a, for example by being held in place by snap fit connections or adhesives, that would work with a like plurality of grommets 118 provides along the top side 61 of panel 60 in a spaced apart fashion to mirror the location of hooks 116.

FIG. 10E shows another setoff spaced apart hooks 120 provided on side 26a of cover 18 that could be sued with a like plurality of loops of material 122 that would fit over hooks 120 as shown.

It would also be possible, for example, to mount panels to the inside surfaces of the cover side portions 24a, 26a and 28a by the use rods mounted to those side portions and to then provide loops on the top sides of the panels that could slid over rods (not shown) or by use of snaps on each of the cover sides 24a-28a and the top sides 51, 61 and 71 of the panels, respectively (not shown).

It should be understood that while various example of how to attach or removably attach the panels making up the camping wrap 40 to cover 18 have been shown for panel 60, relative to cover inside edge 26a, the same approaches apply to panels 50 and 70 and their top sides and the corresponding cover inside portions 24a and 28a, respectively.

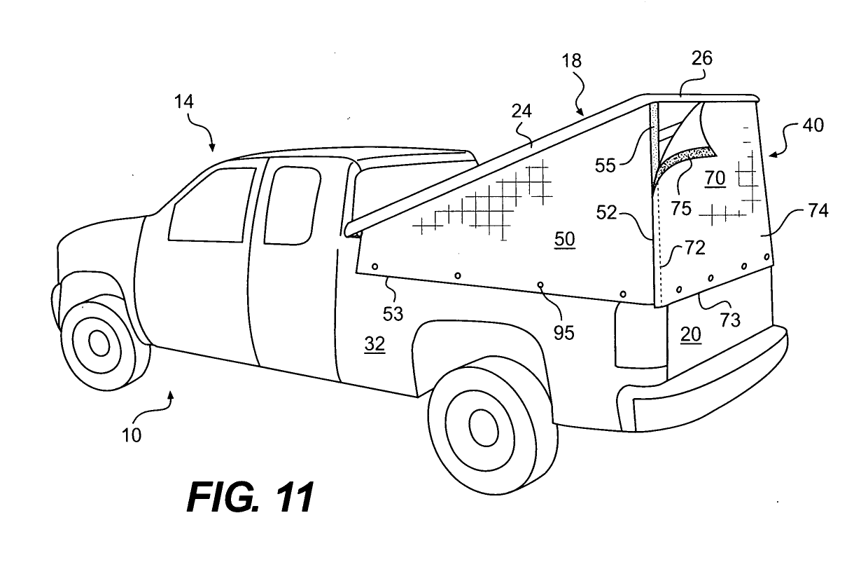

FIG. 11 shows cover wrap 40 as deployed and closed except for one upper corner where the Velcro strips 55 and 75 for ends 52 and 72, respectively, are shown as they are about to be either closed or opened. The bottoms 53 and 73 of panels 50 and 70, respectively, are shown as hanging down over the truck sides 32 and tail gate 20 and that a plurality of magnets 95 located at spaced apart positions along the bottoms will hold those bottom portions against the truck or vehicle sides so that they will not be blown outwardly or easily moved.

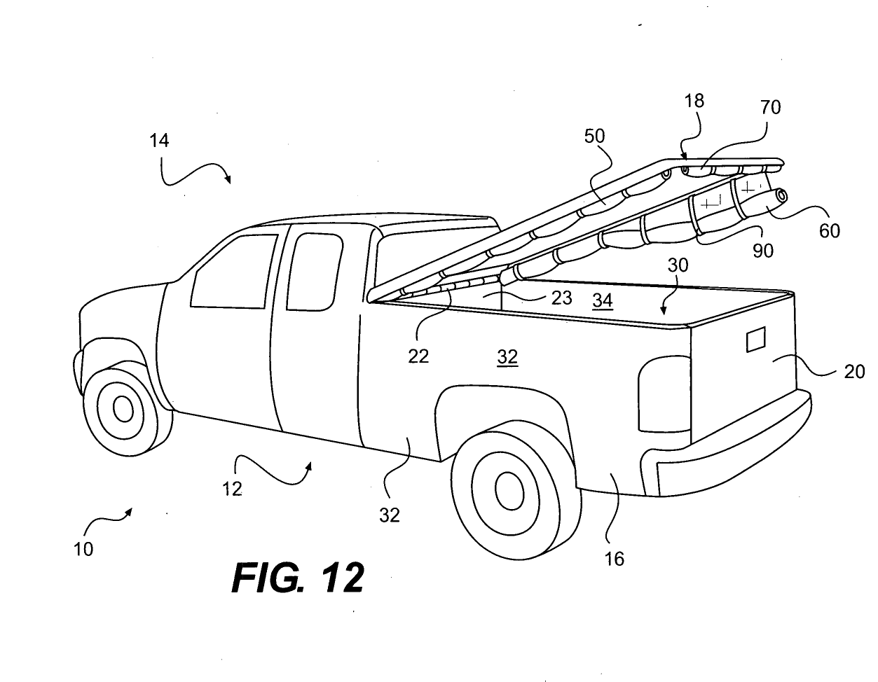

Each panel 50, 6 and 70 of camping wrap 40 can be stored in a rolled up fashion and this is shown in FIG. 12 where the panels are shown being retained or held in that rolled condition by a plurality of spaced apart ties or straps 90 that can be tied in place or the ends could be retained by Velcro. With the panels 50, 60 and 70 in such a rolled up condition cover 18 will be able to be fully closed and used in a normal manner.

It should be understood that the panel shapes and their dimensions as set forth above are exemplary and that actual shapes and panel dimensions will be able to vary without departing from the invention as precise dimensions and panel shapes will be dependent upon the bed, the cover and other such details of the size of the bed for which the camper wrap 40 will be used.

### D. Operation

To use the camper wrap 40 the cover will be raised from its closed to its open position, and when inside the bed 30 one can untie or release the straps 90 and simply unroll the individual panels. Then the adjacent ends 55, 75 and 76, 65 can be releasably interlocked or releasably joined together so that the panels will collectively produce an enclosed space suitable for camping and other purposes. When finished one can reverse this process by undoing or releasing the interlocked ends and then roll each panel up into a tight package so that they can be stored directly on cover 18, for ready use again, using straps 90 after which cover 18 can be closed.

### E. Options and Alternatives

The camper wrap can also be taken down completely by removing each panel 50, 60 and 70 from its connection with cover 18 and stored in a tote or other container after being rolled or folded up in an appropriate size. Also, the materials used for panels 50, 60 and 70 could be tent material, nylon sheeting, rip-stop Nylon, polyester materials, polyester taffeta, polyethylene, polyurethane, Gore-Tex, Todd-Tex, Uv-Tex 5, cotton canvas, No-See-Um Mesh, anti-wicking materials, other waterproof materials, or

As shown in the figures, panels 50, will over-lie the outside of the sides 32, 34 and tail gate 20 and to help hold the bottom portions in place instead of using magnets 95 one can use adjustable tie downs, bungee cords that could attach to a bottom of the vehicle or to wheel wells or bumpers, or other types of devices to hold the bottom edges of the panels in a tight downward condition against the vehicle.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

I claim :

1. A camper wrap comprising:
first, second and third panels, each having an upper edge, a pair of side edges and a bottom edge;
each upper edge including a fastening system extending there along; and
as deployed the second panel will have each of its pair of side edges positioned adjacent one of the pair of side edges of each of the first and third panels, with each of the adjacent side edges including a cooperating fastening system to permit a releasable interlocking of such adjacent edges.

2. The camper wrap as in claim 1 wherein the first and second panels have an upper portion in the shape of a right triangle and the third panel has a trapezoidal shape.

3. The camper wrap as in claim 2 wherein the first and second panels have a bottom portion that extends downwardly from the upper portion.

4. The camper wrap as in claim 1 further including Velcro attachments extending along the adjacent side edges.

5. The camper wrap as in claim 1 wherein one of the pair of side edges on each of the first and third panels positioned adjacent the second has a length greater than the other of the pair of side edges.

6. The camper wrap as in claim 1 wherein the bottom edge of each of the first and third panels has a length that is less than the length of the upper edge thereof.

7. The camper wrap as in claim 1 wherein the length of the bottom edge of the second panel is greater than the length of the upper edge thereof.

8. The camper wrap as in claim 1 further including a plurality of retainer devices at least at spaced apart locations to hold the bottom edge of the panels in place.

9. The camper wrap as in claim 8 wherein the plurality of retaining devices comprises magnets attached to the panels.

10. The camper wrap as in claim 8 wherein the plurality of retaining devices comprises tie downs.

11. The camper wrap as in claim 8 wherein the plurality of retaining devices comprises grommets attached to the panels.

12. A vehicle having a bed covered by a raise-able cover comprising:
a cover assembly having outer and inner surfaces and defined by an outer periphery having opposing sides and opposing ends, the cover assembly being pivotally attached at one of the opposing ends to the vehicle; and
a cover wrap comprised of a plurality of panels each having an upper edge attached to a respective portion of an interior section of the opposing sides and to the other of the opposing ends of the cover assembly to thereby extend along that part of the outer periphery of the cover assembly other than the pivotally attached end thereof,
wherein as deployed one of the plurality of panels will have each of a pair of side edges positioned adjacent one of a pair of side edges of each of the other of the plurality of panels, with each of the adjacent side edges including a cooperating fastening system to permit interlocking of such adjacent edges.
